(19) United States
(12) Patent Application Publication
(10) Pub. No.: US 2013/0036585 A1
(43) Pub. Date: Feb. 14, 2013

(54) DEVICE TO REMOVE WINDOW FRAMES

(71) Applicants: Antonio Nieto, Exeto, CA (US); Elodio Nieto, Exeto, CA (US)

(72) Inventors: Antonio Nieto, Exeto, CA (US); Elodio Nieto, Exeto, CA (US)

(21) Appl. No.: 13/209,421

(22) Filed: Aug. 14, 2011

(51) Int. Cl. B25B 27/14

(52) U.S. Cl. 29/267

(57) ABSTRACT

The present invention is a window frame removal device to remove a window frame that includes an extendable handle to provide additional leverage to a user while removing the window frame and a curved surface that is disposed on the distal end of the extendable handle. The window frame removal device also includes a support brace that includes a pair of support bars angularly extending from each side of the extendable handle to the curved surface and a plurality of locking pliers that attach the window frame removal device to the window frame to be removed by the user.

### TECHNICAL FIELD & BACKGROUND

When replacing windows, users often have to repair the window siding once it has been removed and reapply stucco to the top of the siding, which is laborious and time consuming. Currently there are limited alternatives of products which properly remove window frames while helping to prevent damage to drywalls, stucco and window sills.

The present invention generally relates to a removal device. More specifically, the invention is a window frame removal device.

It is an object of the invention to provide a window frame removal device that is relatively easy to utilize to remove a window frame.

It is an object of the invention to provide a window frame removal device that removes a window frame relatively quickly.

What's really needed is a window frame removal device that is relatively easy to utilize to remove a window frame and that removes a window frame relatively quickly.

### BRIEF DESCRIPTION OF THE DRAWINGS

The present invention will be described by way of exemplary embodiments, but not limitations, illustrated in the accompanying drawings in which like references denote similar elements, and in which:

FIG. 1A illustrates a front perspective view of a window frame removal device, in accordance with one embodiment of the present invention.

FIG. 1B illustrates a side perspective view of a window frame removal device, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is utilized repeatedly. The phrase generally does not refer to the same embodiment, however, it may. The terms “comprising”, “having” and “including” are synonymous, unless the context dictates otherwise.

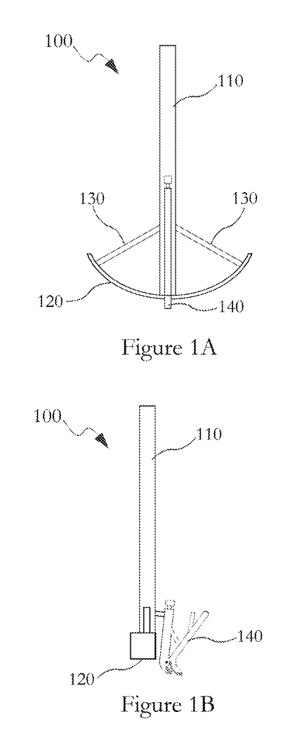

FIG. 1A illustrates a front perspective view of a window frame removal device 100, according to the present invention. The window frame removal device 100 includes an extendable handle 110, a curved surface 120, a support brace 130 and a plurality of locking pliers 140.

The extendable handle 110 is capable of extending up to approximately 30″ to provide additional leverage to a user while removing a window frame (not shown). The extendable handle 110 is made of steel and has a contoured rubber surface 112 that serves as a gripping surface disposed on the top portion 114 of the extendable handle 110. The curved surface 120 is disposed on the distal end 122 and further enhances leverage when used by a user. The support brace 130 includes a pair of support bars 132 angularly extending from each side of the extendable handle 110 to the curved surface 120 that provide support and strength to the window frame removal device 100. The locking pliers 140 attach the window frame removal device 100 to the window frame desired to be removed by a user.

FIG. 1B illustrates a side perspective view of a window frame removal device 100, according to the present invention. The window frame removal device 100 illustrated in FIG. 1A and described in the FIG. 1A description includes the same components as the window frame removal device 100 illustrated and described in FIG. 1B and its description. The extendable handle 110, the curved surface 120, the support brace 130 and the plurality of locking pliers 140 in FIG. 1A is identical to the extendable handle 110, the curved surface 120, the support brace 130 and the plurality of locking pliers 140 in FIG. 1B.

The window frame removal device is comprised of a 30″ long steel handle with a support brace and a curved surface equipped with locking pliers. The window frame removal device is comparable in shape to a crossbow and affords a plurality of users a superior alternative to current window frame removal tools. The window frame removal device is easy to use, where a user simply attaches the locking pliers to the aluminum window frame and utilizing the handle, applies leverage in key locations to relatively easily and safely remove the window frame(s) without breaking the stucco or cutting the siding. Among those who will find the window frame removal device useful are window installers, contractors and everyday users. The window frame removal device features an aluminum window frame removal tool with an extendable steel bar for additional leverage. The window frame removal device is designed with a rubber faced contoured surface for added convenience and efficiency.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

1. A window frame removal device to remove a window frame, comprising:
an extendable handle with a top portion, two sides and a distal end to provide additional leverage to a user while removing said window frame;
a curved surface that is disposed on said distal end of said extendable handle; and
a support brace that includes a pair of support bars angularly extending from each said side of said extendable handle to said curved surface; and
a plurality of locking pliers that attach said window frame removal device to said window frame to be removed by said user.

2. The device according to claim 1, wherein said extendable handle has a contoured rubber surface disposed on said top portion.

3. The device according to claim 1, wherein said curved surface further enhances leverage when used by said user.

4. The device according to claim 1, wherein said support brace provides support and strength to said window frame removal device.

5. The device according to claim 1, wherein said window frame is made of aluminum.

6. A window frame removal device to remove an aluminum window frame, comprising:
an extendable handle with a top portion, two sides and a distal end to provide additional leverage to a user while removing said window frame;
a curved linear surface that is disposed on said distal end of said extendable handle; and
a support brace that includes a pair of support bars angularly extending from each said side of said extendable handle to said curved surface; and
a plurality of locking pliers that attach said window frame removal device to said window frame to be removed by said user.

7. The device according to claim 6, wherein said extendable handle has a contoured rubber surface disposed on said top portion.

8. The device according to claim 6, wherein said extendable handle is made of steel.

9. The device according to claim 6, wherein said curved surface further enhances leverage when used by said user.

10. The device according to claim 6, wherein said support brace provides support and strength to said window frame removal device.

11. The device according to claim 6, wherein said window frame is made of aluminum.

12. The device according to claim 6, wherein said device easily and safely removes said window frame without breaking any surrounding stucco or cutting any surrounding siding around said window frame.

13. The device according to claim 6, wherein said device is crossbow-shaped.

14. A window frame removal device to remove an aluminum window frame, comprising:
a steel extendable handle with a top portion, two sides and a distal end to provide additional leverage to a user while removing said window frame;
a curved linear surface that is disposed on said distal end of said extendable handle; and
a support brace that includes a pair of support bars angularly extending from each said side of said extendable handle to said curved surface; and
a plurality of locking pliers that attach said window frame removal device to said window frame to be removed by said user.

15. The device according to claim 14, wherein said extendable handle has a contoured rubber surface disposed on said top portion.

16. The device according to claim 14, wherein said extendable handle is extended up to approximately 30 inches.

17. The device according to claim 14, wherein said curved surface further enhances leverage when used by said user.

18. The device according to claim 14, wherein said support brace provides support and strength to said window frame removal device.

19. The device according to claim 14, wherein said device easily and safely removes said window frame without breaking any surrounding stucco or cutting any surrounding siding around said window frame.

20. The device according to claim 14, wherein said device is crossbow-shaped.
